(19) United States
(12) Patent Application Publication
(10) Pub. No.: US 2003/0172879 A1
(43) Pub. Date: Sep. 18, 2003

(54) Chew toy holding apparatus

(76) Inventor: Michael P. Bader, Jeffersonville, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/389,128

(22) Filed: Mar. 14, 2003

Related U.S. Application Data
(60) Provisional application No. 60/365,270, filed on Mar. 18, 2002.

(51) Int. Cl. A01K 29/00

(52) U.S. Cl. 119/709

(57) ABSTRACT

A chew toy holding apparatus is provided. The holding apparatus includes a base platform and means coupled to the base platform for detachably securing a chew toy in a fixed position relative to the base platform during chewing of the chew toy by a pet.

### CROSS REFERENCE TO RELATED APPLICATIONS

This application claims priority to U.S. Provisional Patent Application Serial No. 60/365,270 to Michael P. Bader entitled “Bone Stand Apparatus” filed Mar. 18, 2002, the entirety of which is hereby incorporated by reference herein.

### FIELD OF INVENTION

The present invention relates to chewable pet toys, and more particularly, to holding devices therefor.

### BACKGROUND OF THE INVENTION

Many pets, particularly dogs, spend large amounts of time chewing pet toys, such as synthetic and rawhide bones, rubber chew products, plastic chew products (e.g., “squeaky” toys) and stuffed fabric chews, to name a few. This process is natural for pets and is generally encouraged by veterinarians for digestive reasons and other reasons, including tarter and plaque removal and teeth, gum and jaw conditioning.

Sometimes, dogs and other pets lack the ability to effectively manipulate chew toys into the variety of positions required for effective hygienic results. This may occur, for example, because an animal generally lacks the requisite dexterity, because of injury or medical procedure or because of lameness.

There are also human-centric issues related to chew toys. Chew toys are generally left on the floor by pets. The toys, although acceptable for pets, are perceived by many people as being “dirty” or “messy.” Many pets prefer that an owner or other human engage in the chewing activity with the pet by holding the chew toy. It is believed that pets enjoy the tugging resistance provided by a person on the chew toy and, by and large, that pets derive pleasure from the proximity of their owners or other humans. Holding the chew toy often is, or can become, uncomfortable for many people, either because of the time required to do so or because the chew toy has been in the pet's mouth and on the floor.

Several references disclose chew toy apparatuses. U.S. Pat. No. 5,339,770 to Haffner describes an exercise and amusement toy for a dog having an umbrella shaped dome with toys that dangle from the dome by lines.

U.S. Pat. No. 6,217,408 to Willinger describes a molded rubber pet toy with a hemispherical base for self righting the toy.

U.S. Pat. No. 5,148,769 to Zelinger describes an amusement toy for pets having an arcuately shaped spring-like wire removably mounted at one end to a suction cup and having a pet toy suspended from a free end thereof.

U.S. Pat. No. 2,194,736 to Bruler shows an animal exercise and amusement device having a chew toy connected to an elongated elastic member that couples to a door knob.

Finally, U.S. Pat. No. 5,634,436 to Coombs et al. discloses an exercise and amusement device for animals that provides noises when the animal pulls on a portion of the device.

Despite the above contributions to the art, there still remains a need for an apparatus that firmly engages a chewable pet toy and that improves the chewing experience for the pet and/or owner.

### SUMMARY OF THE INVENTION

A chew toy holding apparatus is provided. The holding apparatus includes a base platform and means coupled to the base platform for detachably securing a chew toy in a fixed position relative to the base platform during chewing of the chew toy by a pet.

The chew toy holding apparatus provides a firm foundation for holding a chew toy for a pet. This improves the overall chewing experience for the pet and provides the consequent hygienic benefits to the pet. The holding apparatus provides improved access to the chew toy for animals that lack the ability to manipulate a chew toy, such as pets that have recently had surgery on one or more paws. The owner also does not have to hold the chew toy in order to engage in the chewing experience with the pet. The owner can periodically adjust the position of the chew toy and/or merely be near or touch the base of the chew toy holding apparatus to satisfy the pet's proximity needs. Still further, the chew toy holding apparatus effectively keeps chew toys from being left on the floor or on furniture while allowing for replacement toys to be substituted in the holding apparatus or adjusted to account for wear. In addition, the apparatus serves as an excellent distraction from destructive chewing habits, such as chewing on furniture.

The above and other features will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a side elevational view of a holding apparatus for a chew toy and a chew toy secured thereby;

FIG. 2 is a top plan view of a clamp for securing a chew toy;

FIG. 3 is a cross-section view of the holding apparatus of FIG. 1, taken along lines A-A, better illustrating a ball joint coupled to the base platform thereof;

FIG. 4 illustrates an embodiment of the chew toy holding apparatus including a chuck for securing a chew toy;

FIG. 5 illustrates an embodiment of the chew toy holding apparatus including a locking collar for securing a chew toy;

FIG. 6 illustrates an embodiment of the chew toy holding apparatus including a detachable spike for securing the chew toy holding apparatus to the ground;

FIG. 7 is a partial, exploded view of a portion of a flexible shaft;

FIGS. 8A and 8B illustrate an alternative embodiment of the chew toy holding apparatus with an adjustable element located more proximate to the securing element;

FIG. 9 illustrates a dog chewing on a bone secured by the chew toy holding apparatus;

FIGS. 10A and 10B illustrate an alternative design for a chew toy holding apparatus having gripping teeth for securing a chew toy; and

FIGS. 11A and 11B illustrate an alternative method of securing a chew toy to a chew toy holding apparatus.

### DETAILED DESCRIPTION

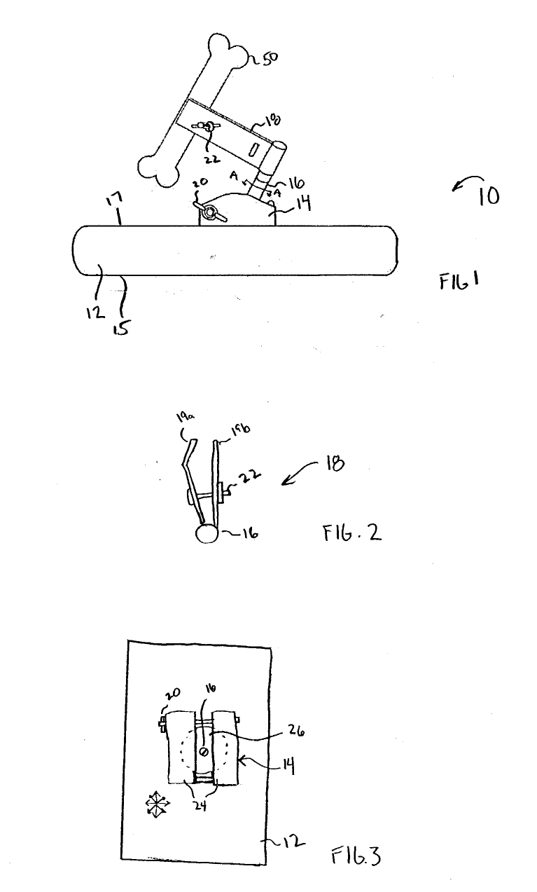

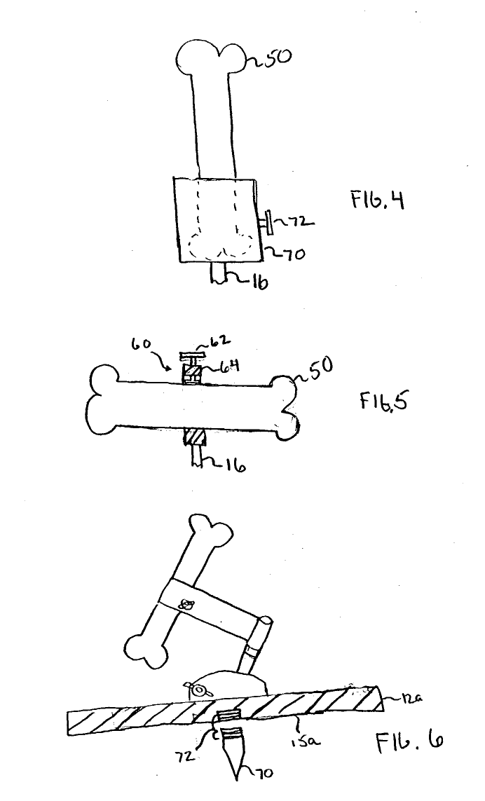

This invention pertains to chew toy holding apparatuses. FIG. 1 is a side elevational view of an exemplary embodiment of a holding apparatus 10 for holding a chew toy, illustrated as a bone 50. The holding apparatus includes a base platform 12 and a ball joint element 14 attached thereto. The ball joint element 14 can be nailed, bolted or screwed to the base platform 12, secured with an adhesive to the base platform 12, formed integrally with the base platform 12, or otherwise coupled to the base platform 12. The ball joint element 14 is better illustrated in the cross-section view of FIG. 3 taken along lines A-A of FIG. 1.

Any conventional ball joint may be utilized. In one embodiment, the ball joint element 14 includes first and second enclosing sections 24 and a ball element 26 disposed therebetween. Extending from the ball element 26 is a shaft or stem 16. A screw element, which is spring loaded in an exemplary embodiment, connects the first and second enclosing sections 24 and is used to fix the ball element 26 in a desired position. When the screw element 20 is loosened by unscrewing a wing nut, the ball element 16 can be rotated or otherwise moved to a selected position, thereby reorienting the stem 16 relative to the base 12. The screw element 20 is then tightened to fix the ball element 26 between the sections 24. In this manner, the stem 16 has a full range of movement, as illustrated by the arrows shown in FIG. 3. Alternatively, the ball joint element 14, or equivalent, can be provided in an unlocked position, so that the pet, zoo animal, or even child, etc. can manipulate the bone 50, to or amusement item, freely. In such an embodiment the ball joint element 14 can be adjustable for various degrees of friction or resistance to movement, such as to allow the amusement item or bone 50 to swivel freely or merely be moved from one position to another under a set amount of force, for example, 1.0 ft-lb. The element may adjustable by, for example, a screw that may be turned to fix the adjustable element in a fixed position, i.e., tightening the screw increases the resistance and loosening the screw decreases the resistance.

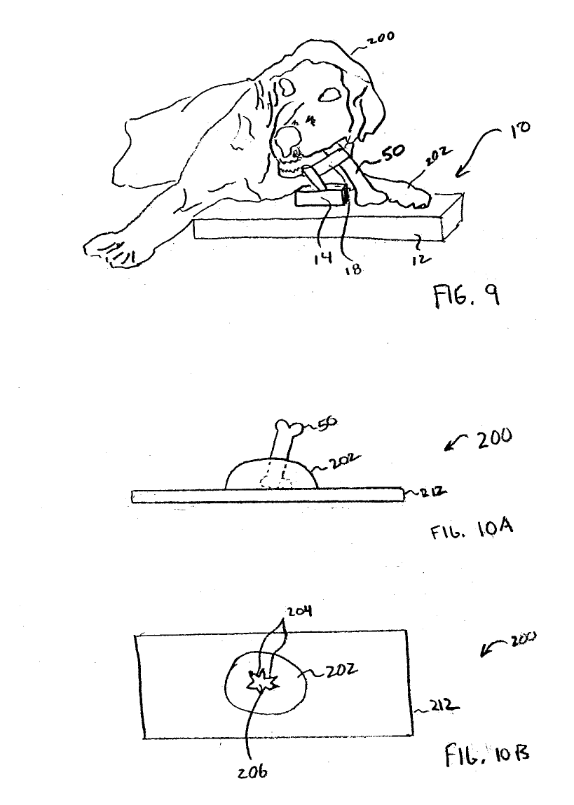

Although the adjusting element is described herein as a screw actuated ball joint, other ball joints, such as the kind typically used to secure a camera on a camera tripod and other adjustable elements may also be utilized, such as a rotateable and lockable element, or an adjustable and lockable hinge joint, ball bearing or plastic self-lubricating bearing joint. As described further below in connection with FIGS. 8A and 8B, the adjustable element need not be directly disposed on the base platform, but may be coupled to the base platform via a shaft or other element such that is disposed more proximate to the securing element described below.

A securing element for detachably securing the chew toy 50 is coupled to the base platform through the stem 16. In one exemplary embodiment, the securing element is a clamp 18. Clamp 18 may be a screw clamp (FIG. 2), a spring loaded screw clamp, or a spring clamp. FIG. 2 is a top plan view of clamp 18. Clamp 18 has first and second clamping arms 19a, 19b. The clamping arm 19b is connected to stem 16 and is coupled to arm 19a by screw element 22. A chew toy 50 is secured between the arms 19a, 19b by tightening the screw element 22.

When in its centered position, i.e., when the shaft 16 is substantially vertical and the securing element 18 is extended parallel to the base platform 12, the securing element preferably has a securing point that is between about 2.5″-5.0″ above the top surface 17 of the base platform 12. It has been found that this height allows the chew toy holding apparatus to operate with most commercially available chew toys, particularly raw hide and synthetic dog bones, and provides a wide range of accessible chewing positions for most pets, particularly dogs.

The base platform 12 is preferably planar. In one embodiment, the base platform 12 is generally rectangular and has dimensions between about 12×6×1″ to about 20×10×2″. It is believed that these dimensions provide an adequate support platform for the adjustable and securing elements coupled thereto while providing sufficient room for most pets, particularly dogs, to rest their forearms on the platform. Still further, this base platform is adequately sized to collect debris that detaches from chew toys. Of course, the base platform 12 may be formed into other shapes, such as a circle, square, octagon, etc., as long as the base platform 12 is relatively stable during normal chewing action. Stability is generally a factor of weight, shape and size of the platform, which may all be a factor of the material selected for manufacture.

In operation, the chew toy holding apparatus 10 detachably grips a chew toy 50 and secures the chew toy 50 in a fixed position relative to the base platform 12. The pet, e.g., a dog, can operate on the chew toy from a variety of angles while it is fixed. The chew toy can be moved to at least a second fixed position relative to the base platform 12 by reorienting the ball element 26 within the sections 24 and/or by altering the position of the chew toy 50 as gripped by the clamp 18. This allows the chew toy to be fixed in a plurality of different position, thereby allowing the chew toy holding apparatus 10 to be customized for pets of all different sizes and abilities. Fixing the chew toy above the base platform and off of the floor increases the angles at which a pet can operate on the chew toy. This improves the overall chewing experience for the pet and provides the consequent hygienic benefits to the pet.

The chew toy 50 is securely held in place by the securing element, thereby providing access to the chew toy for animals that lack dexterity, such as pets that have recently had surgery on one or more paws or that are lame. These pets lack the ability to secure a chew toy in an upright position between their paws. The owner also does not have to hold the chew toy in order to engage in the chewing experience with the pet. The owner can periodically adjust the position of the chew toy and/or merely be near to or touch the base of the chew toy holding apparatus to allow the pet to think that the owner is engaged in the act with the pet, thereby providing a proximity awareness benefit. Still further, the chew toy holding apparatus affectively keeps chew toys from being left on the floor or on furniture. Also, the chew toy can be replaced when worn or reoriented to account for wear.

Still further, the chew toy holding apparatus provides an ant-choking benefit. Any remaining nub of a bone, for example, remains secured by the securing element. This prevents the pet from swallowing the nub and allows the owner to properly dispose of it.

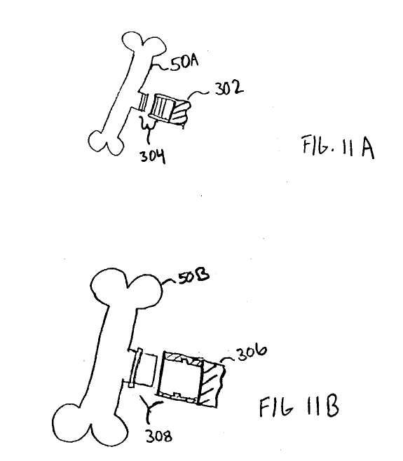

FIG. 10 illustrates a dog 200 chewing on a bone 50 secured to the chew toy holding apparatus 10. The bone 50 is positioned in a desired location by the owner, and the dog 50 commences chewing on the bone 50. The chew toy holding apparatus 10 provides a stable platform through base 12 for the adjustable element 14, the securing element 18 and the animal's paw 202 or paws. Observations of the applicant's dog while chewing on a bone secured by the chew toy holding apparatus 10 as shown in FIGS. 1 and 10 revealed that the pet had excellent leverage on and access to a secured bone. Further, the pet engaged in chewing for a longer period of time when compared to merely placing a bone on the floor. The increased leverage and improved access provide for improved scraping and cleaning of teeth. The increased chewing time serves as a distraction and deterrent from damaging behavior, such as chewing on furniture. Many pets enjoy chewing on “vertical” structures, such as chair or table legs. A bone or other chew toy can be oriented in the holding apparatus to mimic these structures.

The chew toy holding apparatus can be constructed of many different materials, such as plastic or metal. The base platform 12 may be constructed of plastic, metal or wood. In one exemplary embodiment, the base platform 12 includes a removable cover (not shown), such as a carpeting or other fabric, that can be removed and washed. In connection with base platform 12, the cover serves to collect saliva and pieces of the chew toy that fall thereon. The cover may be attached to the base platform by hook and loop fastener strips (e.g., VELCRO® strips), buttons or elastic means or include a zipper or tie means for closing the cover around the base platform 12, for example.

Although the securing element for fixedly and detachably securing the chew toy 50 is shown as a screw clamp 18, other elements may be used to secure the chew toy 50. Other examples of securing elements include, but are not limited to, spring clamps, chuck elements, locking collars (such as those used to secure weights to a bar, only the chew toy is substituted for the bar) and the like. Alternatively, a metal, plastic or cotton rope or chain could be employed, whereby the chew toy 50, for example, is dangled from the stem 16 at some set height above the top surface 17 of the base platform 12.

FIG. 4 illustrates a chuck 70 employed to secure the chew toy 50. The chuck 70 is coupled to stem 16, which is preferably swivally mounted via the ball joint described above. The chuck is tightened around the chew toy 50 via screw or key element 72.

FIG. 5 illustrates in cross-section a locking collar 60 for securing a chew toy 50. The locking collar 60 is coupled to stem 16. The chew toy 50 is disposed through the ring 64 (assuming the chew toy is properly sized), and the chew toy is secured thereto by tightening screw or key 62.

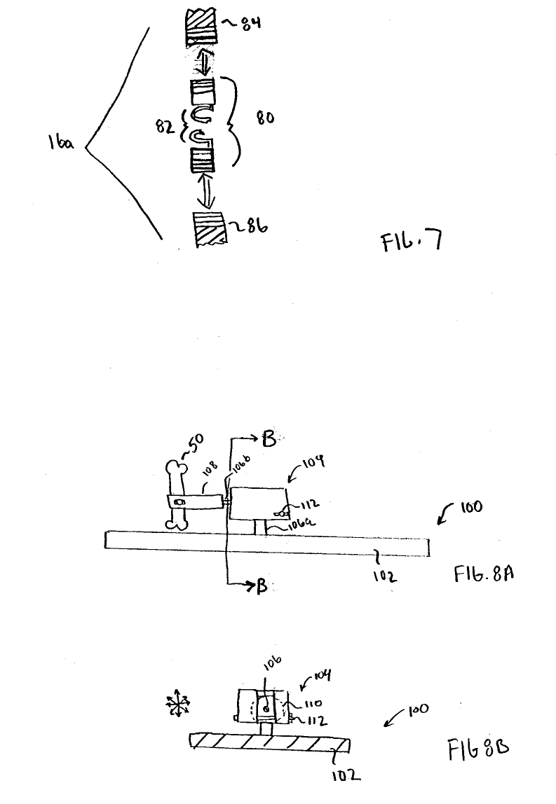

In one embodiment of the present invention, the base platform includes one or more suction cups (not shown) coupled to a bottom surface of the base platform. The suction cups help to securely fasten the base platform to a floor, such as a linoleum, hardwood or tile floor. It is contemplated that the base platform itself could be a suction cup, such as a plunger bottom. In yet another embodiment of the chew toy holding apparatus shown in the exploded view of FIG. 6, the base platform 12a includes one or more detachable cork screw or spike elements 70 for use outside. The cork screw or spike 70 is driven into the ground to secure the device thereto. The cork screw or spike 70 can attach to the bottom surface 15a of the base platform 12a by, for example, cooperable screw means 72 disposed in base platform 12a and on the cork screw or spike 70. The spike 70 is removed for indoor use.

In another embodiment, shaft 16 includes a flexible portion that allows some movement of the chew toy 50 during chewing. As shown in the partial exploded view of a shaft 16a in FIG. 7, shaft 16a includes a bottom shaft section 86 and a top shaft section 84, both shown in cross section. Each shaft section 84, 86 includes cooperable screw means for engaging with a central flexible section 80. In one embodiment, the central flexible section includes a spring portion 82 (shown in partial) that provides flex to the shaft during chewing of the chew toy apparatus by a pet. The spring portion 82 should have sufficient strength to provide a tugging action between the holding apparatus and the pet during chewing. Of course, the shaft may be made flexible in other ways, such as by material design, by designing a bow into the shaft, or by utilizing an adjustable shaft portion as may be found on a microphone stand, for example.

Still further, the shaft itself may be fixedly adjustable at an intermediate point or at a point connecting to the securing means to allow the securing means to be adjusted relative to the base platform. This feature can be in addition to or in lieu of the ball joint adjusting element 18 at the base platform 12. For example, referring to FIGS. 8A and 8B, a chew toy holding apparatus 100 is shown including base platform 102, shaft sections 106a and 106b, and ball joint element 104. The clamp 108 is coupled to the base platform 102 via shaft section 106a and intermediate ball joint element 104. FIG. 8B shows the holding apparatus in cross-section taken along lines B-B. Key element 112 is utilized to loosen and tighten the ball 110 to allow for reorientation of clamp 108, as indicated by arrows shown in FIG. 8B. Of course, other adjustable elements can be substituted for ball joint 104, such as an adjustable and lockable hinge joint, or a rotateable and lockable element.

FIGS. 10A and 10B illustrate an alternative embodiment of a chew toy holding apparatus 200. FIG. 10A is a side elevational view illustrating the apparatus 200 and a bone 50. FIG. 10B is a top plan view illustrating the apparatus 200 without a bone. The holding apparatus includes a base platform 212. A dome shaped securing element 202 is coupled to the base platform 212. The dome shaped securing element includes an aperture 206 formed therein. The aperture 206 is defined by a plurality of teeth elements 204 formed around the circumference of the aperture 206. The aperture is preferably sized such that the teeth engage the bone 50 as it is disposed within the dome 202 to secure the bone 50 in a selected position. The dome is preferably formed from a tough, shatter resistant plastic material, such as polycarbonate, nylon, polypropylene, acetal, acrylic or PVC, for example, having a preferred impact strength of at least about 4 Kj/m at 20° C., that has sufficient give to allow insertion and removal of the bone but sufficient rigidity to secure the bone during chewing thereof.

FIGS. 11A and 11B illustrate an alternative securing element utilizing a male-female connector. As shown in FIG. 11A, the chew toy 50A and securing element 302 (shown in partial, cross-section) include cooperable screw means 304 for securing the chew toy 50B to the securing element 302. FIG. 11B illustrates an alternative male-female snap-fit connection 308 between a chew toy 50B and securing element 306 (shown in partial, cross-section).

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A chew toy holding apparatus; comprising:
(a) a base platform; and
(b) means coupled to said base platform for detachably securing a chew toy in a fixed position relative to said base platform during chewing of said chew toy by a pet.

2. The apparatus of claim 1 further comprising means for adjusting said securing means from a first fixed position relative to said base platform to at least a second fixed position relative to said base platform.

3. The apparatus of claim 2, wherein said securing means includes a clamp.

4. The apparatus of claim 3, wherein said clamp includes spring or screw for actuating said clamp.

5. The apparatus of claim 2, wherein said securing means includes a chuck.

6. The apparatus of claim 2, wherein said securing means includes a locking collar.

7. The apparatus of claim 2, wherein said adjusting means includes a ball joint.

8. The apparatus of claim 1, wherein said securing means is coupled to said base platform by a stem portion, said securing means disposed to secure said chew toy at a point above said platform between about 2.0-5.0 inches.

9. The apparatus of claim 1, wherein said securing means is selected from the group consisting of a clamp, a chuck, a locking collar and a male-female connection.

10. The apparatus of claim 1, further comprising a removable cover coupled to said base platform, said removable cover positioned to collect debris that detaches from a chew toy secured by said securing means.

11. A chew toy holding apparatus comprising:
(a) a base platform;
(b) means coupled to said base platform for detachably securing a chew toy in a fixed position relative to said securing means during chewing of said chew toy by a pet; and
(c) means for fixedly adjusting an orientation of said securing means relative to said base platform.

12. The apparatus of claim 11, wherein said securing means is coupled to said base platform by a stem portion, at least a portion of said stem portion being flexible.

13. The apparatus of claim 11, wherein said adjusting means includes a ball joint.

14. The apparatus of claim 11, wherein said securing means is selected from the group consisting of a clamp, a chuck, a locking collar and a male-female connection.

15. The apparatus of claim 11, further comprising a chew toy secured by said securing means.

16. The apparatus of claim 11, further comprising a removable cover coupled to said base platform, said removable cover positioned to collect debris that detaches from a chew toy secured by said securing means.

17. A chew toy holding apparatus, comprising:
(a) a base platform; and
(b) means coupled to said platform for detachably gripping a chew toy in a fixed position relative to said gripping means during chewing of said chew toy by a pet.

18. The apparatus of claim 17, wherein said base platform includes means for securing said platform to a surface.

19. The apparatus of claim 17, wherein said means includes at least one suction device.

20. The apparatus of claim 17, wherein said base platform includes spike or screw means for securing said base platform to ground.

21. The apparatus of claim 17, further comprising means for fixedly adjusting an orientation of said securing means relative to said based platform.

22. The apparatus of claim 21, wherein said fixedly adjusting means includes a ball joint and said securing means is coupled to said ball joint by a stem portion.

23. The apparatus of claim 17, further comprising a removable cover coupled to said base platform, said removable cover positioned to collect debris that detaches from a chew toy secured by said securing means.

24. A chew toy holding apparatus, comprising:
(a) a base platform;
(b) means coupled to said base platform for detachably securing a chew toy in a fixed position relative to said securing means during chewing of said chew toy by a pet; and
(c) swivel means for allowing the pet to adjust an orientation of said securing means relative to said base platform.

25. The apparatus of claim 24, wherein said swivel means is adjustable to various degrees of friction.
